(19) United States
(12) Patent Application Publication
(10) Pub. No.: US 2025/0218182 A1
(43) Pub. Date: Jul. 3, 2025

(54) INFORMATION PROCESSING DEVICE, SYSTEM AND METHOD FOR OPERATING SYSTEM

(71) Applicant: TOYOTA JIDOSHA KABUSHIKI KAISHA, Toyota-shi (JP)

(72) Inventors: Hideyuki TAKAKI, Okazaki-shi (JP); Yusuke Tsumita, Kashiwa-shi (JP); Satoshi KAJIYAMA, Ibaraki-shi (JP); Yasuhiro KOBATAKE, Nagoya-shi (JP); Takafumi YAMADAIRA, Nagoya-shi (JP); Kumiko HAYASHI, Nagoya-shi (JP); Tomoya KAJIKAWA, Nagoya-shi (JP)

(73) Assignee: TOYOTA JIDOSHA KABUSHIKI KAISHA, Toyota-shi (JP)

(21) Appl. No.: 18/940,281

(22) Filed: Nov. 7, 2024

(30) Foreign Application Priority Data
Dec. 27, 2023 (JP) 2023-221530

(51) Int. Cl. G06V 20/52; G06Q 10/0833

(52) U.S. Cl. CPC G06V 20/52; G06Q 10/0833

(57) ABSTRACT

An information processing device includes a communication device, a memory that stores identification information of a specified vehicle and identification information of a terminal device of a purchaser of the specified vehicle in association with each other, and a controller that acquires an image captured during transportation of the specified vehicle from an imaging device via the communication device and sends the captured image to the terminal device.

### CROSS-REFERENCE TO RELATED APPLICATION

This application claims priority to Japanese Patent Application No. 2023-221530 filed on Dec. 27, 2023, incorporated herein by reference in its entirety.

### BACKGROUND

### 1. Technical Field

The present disclosure relates to an information processing device, a system, and a method for operating a system.

### 2. Description of Related Art

Technologies that present to a user, for example, a shipping status of a product purchased by the user until the product is delivered to the user, are known. For example, since it takes a certain amount of time to deliver a vehicle to a user who purchased the vehicle, technologies have been proposed that present, to the user, a progress status until delivery of the vehicle. For example, Japanese Unexamined Patent Application Publication No. 2002-297954 discloses a system for providing a user terminal with information on a progress status of a vehicle before delivery of the vehicle, which is stored in a progress management DB.

### SUMMARY

There is room to inspire the feeling of expectation of users who wait for delivery of their vehicles, and enhance their interest.

An information processing device and the like that can inspire the feeling of expectation of users who wait for delivery of their vehicles, and enhance their interest will be disclosed below.

An information processing device according to a first aspect of the present disclosure includes a communication device; a memory configured to store identification information of a specified vehicle and identification information of a terminal device of an owner of the specified vehicle, the identification information of the specified vehicle and the identification information of the terminal device being associated with each other; and a controller configured to obtain an image captured during transportation of the specified vehicle from an imaging device via the communication device, and send the captured image to the terminal device.

In the information processing device according to the above aspect, the owner of the specified vehicle may be a purchaser of the specified vehicle.

An information processing device according to a second aspect of the present disclosure includes a communication device, a memory configured to store identification information of a specified vehicle and identification information of a terminal device of a purchaser of the specified vehicle, the identification information of the specified vehicle and the identification information of the terminal device being associated with each other, and a controller configured to obtain an image captured during transportation of the specified vehicle from an imaging device via the communication device, and send the captured image to the terminal device.

In the information processing device according to the above aspect, the controller may cause the imaging device to capture an image of the specified vehicle on condition that the specified vehicle is located at a predetermined transport base.

In the information processing device according to the above aspect, the controller may cause the imaging device to capture an image of the specified vehicle on condition that a request from the terminal device is received.

In the information processing device according to the above aspect, the controller may send, to the terminal device, information indicating a process in which the specified vehicle is transported.

In the information processing device according to the above aspect, the captured image may include an external appearance of the specified vehicle captured at a transport base of the specified vehicle.

In the information processing device according to the above aspect, the captured image may include an external appearance of a packaging style of the specified vehicle captured at a transport base of the specified vehicle.

In the information processing device according to the above aspect, the external appearance of the packaging style may include the identification information of the specified vehicle.

A system according to a third aspect of the present disclosure includes an information processing device and a terminal device, the information processing device storing identification information of a specified vehicle and identification information of the terminal device of a purchaser of the specified vehicle, the identification information of the specified vehicle and the identification information of the terminal device being associated with each other, wherein the information processing device obtains an image captured during transportation of the specified vehicle from an imaging device, and sends the captured image to the terminal device, and the terminal device outputs the captured image.

In the system according to the above aspect, the information processing device may cause the imaging device to capture an image of the specified vehicle on condition that the specified vehicle is located at a predetermined transport base.

In the system according to the above aspect, the information processing device may cause the imaging device to capture an image of the specified vehicle on condition that a request from the terminal device is received.

In the system according to the above aspect, the information processing device may send, to the terminal device, information indicating a process in which the specified vehicle is transported, and the terminal device may output the information indicating the process.

In the system according to the above aspect, the captured image may include an external appearance of the specified vehicle captured at a transport base of the specified vehicle.

In the system according to the above aspect, the captured image may include an external appearance of a packaging style of the specified vehicle captured at a transport base of the specified vehicle.

In the system according to the above aspect, the external appearance of the packaging style may include identification information of the specified vehicle.

A method for operating a system according to a fourth aspect of the present disclosure that includes an information processing device and a terminal device, the information processing device storing identification information of a specified vehicle and identification information of the terminal device of a purchaser of the specified vehicle, the identification information of the specified vehicle and the identification information of the terminal device being associated with each other, includes obtaining an image captured during transportation of the specified vehicle from an imaging device and sending the captured image to the terminal device by the information processing device, and outputting the captured image by the terminal device.

In the method for operating a system according to the above aspect, the information processing device may cause the imaging device to capture an image of the specified vehicle on condition that the specified vehicle is located at a predetermined transport base.

In the method for operating a system according to the above aspect, the information processing device may cause the imaging device to capture an image of the specified vehicle on condition that a request from the terminal device is received.

The method for operating a system according to the above aspect may further comprise sending, to the terminal device, information indicating a process by the information processing device, the specified vehicle being transported in the process, and outputting information indicating the process by the terminal device.

In the method for operating a system according to the above aspect, the captured image may include an external appearance of the specified vehicle captured at a transport base of the specified vehicle.

In the method for operating a system according to the above aspect, the captured image may include an external appearance of a packaging style of the specified vehicle captured at a transport base of the specified vehicle.

According to the information processing device and the like of the present disclosure, it is possible to inspire the feeling of expectation of a user who waits for vehicle delivery and enhance user's interest.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of an information providing system;

FIG. 2 is a sequence diagram showing an operation example of the information providing system;

FIG. 3 is a diagram showing an example of a display screen of a terminal device; and

FIG. 4 is a sequence diagram showing an operation example of a modification of the information providing system.

### DETAILED DESCRIPTION OF EMBODIMENTS

An embodiment will be described below.

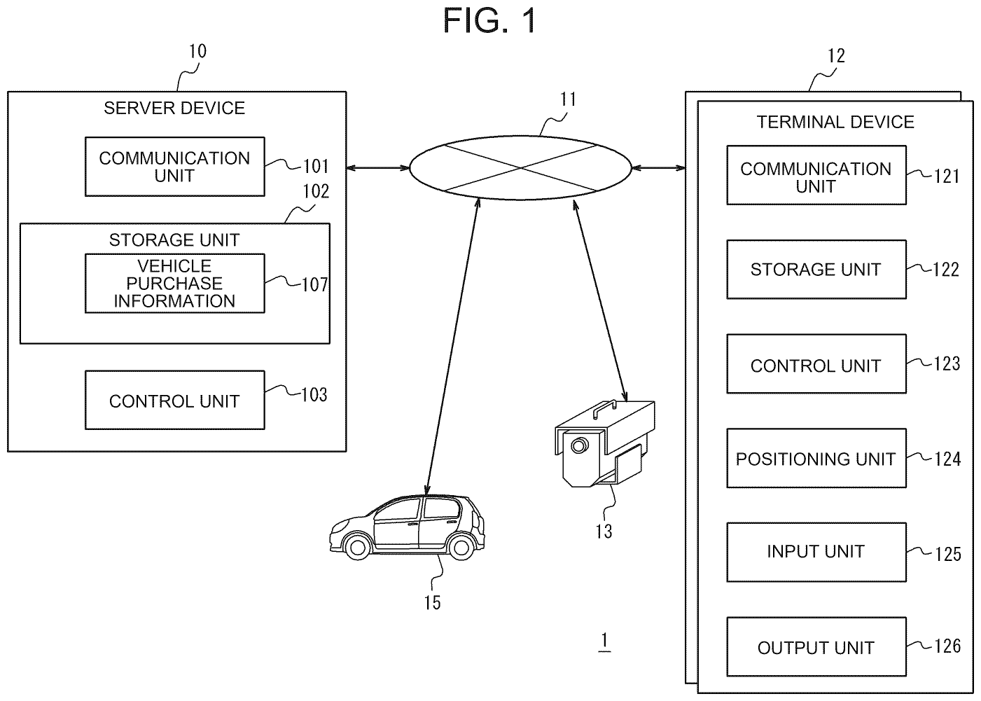

FIG. 1 is a diagram showing a configuration example of an information providing system in an embodiment. The information providing system 1 includes one or more server devices 10, a plurality of terminal devices 12, and one or more imaging devices 13 which are connected to one another via a network 11 such that information can be communicated among them. The server device 10 is, for example, a server computer that belongs to a cloud computing system or other computing systems, and functions as a server for implementing various functions. The server device 10 corresponds to an “information processing device” in the present embodiment. The terminal device 12 is an information processing device having a communication function to be used by a purchaser of a vehicle 15 (hereinafter referred to as a user) or a person in charge of transporting the vehicle 15, and is, for example, a smartphone, a tablet terminal, or the like. The imaging device 13 includes a camera for imaging a vehicle 15 to be transported, and a control device having a communication function for transmitting captured images. The imaging device 13 is installed at a transport base on a transport route of the vehicle 15. The transport base includes a loading base where the vehicle 15 is loaded onto a car carrier, a ship or the like, and maintenance base where the vehicle 15 is maintained during a transport process. The network 11 is, for example, the Internet, but may also be an ad-hoc network, LAN, metropolitan area network (MAN), or another network, or any combination of them.

In the present embodiment, the information providing system 1 assists enhancement of the user's interest until the vehicle 15 purchased by the user is delivered to, for example, a car dealer's store. Specifically, the server device 10 includes a communication unit (communication device) 101, a storage unit (memory) 102, and a control unit (controller) 103. The storage unit 102 stores identification information of a specified vehicle purchased by the user (hereinafter referred to as a purchased vehicle) 15 and corresponding identification information of a purchaser of the purchased vehicle 15, that is the terminal device 12 of the user as vehicle purchase information 107. The control unit 103 acquires, via the communication unit 101, images captured at the time of transportation of the purchased vehicle 15 from the imaging device 13 and sends them to the terminal device 12. The user can watch the images of the purchased vehicle 15 during the transportation process of the purchased vehicle 15, so that the user's feeling of expectation while the user waits for delivery of the vehicle 15 can be inspired. Therefore, it is possible to enhance the user's interest.

### Configuration Example of Server Device 10

The server device 10 includes a communication unit 101, a storage unit 102, and a control unit 103. The server device 10 may be configured by one server computer, or may be configured by two or more computers that are communicatively connected to each other and operate in cooperation with each other. In that case, the configuration shown here is appropriately arranged in the two or more server computers.

The communication unit 101 includes one or more communication interfaces. The communication interface is, for example, a LAN interface. The communication unit 101 receives information to be used in the operation of the server device 10, and transmits information obtained by the operation of the server device 10. The server device 10 is connected to the network 11 by the communication unit 101, and communicates information with other devices via the network 11.

The storage unit 102 includes, for example, one or more semiconductor memories, one or more magnetic memories or one or more optical memories that function as a main storage device, an auxiliary storage device, or a cache memory, or a combination of at least two kinds of these memories. The semiconductor memory is, for example, a random access memory (RAM) or a read only memory (ROM). The RAM is, for example, a static RAM (SRAM) or a dynamic RAM (DRAM). The ROM is, for example, an electrically erasable programmable ROM (EEPROM). The storage unit 102 stores information to be used for the operation of the server device 10, and information obtained by the operation of the server device 10. The storage unit 102 stores vehicle purchase information 107. The vehicle purchase information 107 includes identification information of the purchased vehicle 15 and identification information of the terminal device 12 which are associated with each other.

The control unit 103 includes one or more processors, one or more dedicated circuits, or a combination of these units. The processor is, for example, a general-purpose processor such as a central processing unit (CPU), or a dedicated processor such as a graphics processing unit (GPU) specialized for specific processing. The dedicated circuit is, for example, a field-programmable gate array (FPGA), an application specific integrated circuit (ASIC), or the like. The control unit 103 executes information processing related to the operation of the server device 10 while controlling each part of the server device 10.

The functions of the server device 10 are implemented by executing a control program in a processor included in the control unit 103. The control program is a program for causing the server computer to execute processing of steps included in the operation of the server device 10, thereby causing the server computer to implement the functions corresponding to the processing of those steps. In other words, the control program is a program for causing a computer to function as the server device 10. Furthermore, some or all of the functions of the server device 10 may be implemented by a dedicated circuit included in the control unit 103. Furthermore, the control program may be stored in a non-transient recording/storage medium readable by the server device 10, and read from a medium by the server device 10.

### Configuration Example of Terminal Device 12

The terminal device 12 includes a communication unit 121, a storage unit 122, a control unit 123, an input unit 125, and an output unit 126. The terminal device 12 may also include a positioning unit 124.

The communication unit 121 includes one or more communication interfaces that correspond to wired or wireless LAN standards. The communication interfaces include interfaces corresponding to mobile communication standards such as long term evolution (LTE), 4th generation (4G), or 5th generation (5G). Furthermore, the communication interfaces also include interfaces that correspond to near-field radio communication standards such as Wi-Fi, Bluetooth, or infrared communication. The terminal device 12 is connected to the network 11 via a nearby router device or a base station of mobile communication by the communication unit 121, and communicates information with other devices via the network 11.

The storage unit 122 includes one or more semiconductor memories, one or more magnetic memories, one or more optical memories, or a combination of at least two kinds of these memories. The semiconductor memory is, for example, RAM or ROM. The RAM is, for example, SRAM or DRAM. The ROM is, for example, EEPROM. The storage unit 122 functions, for example, as a main storage device, an auxiliary storage device, or a cache memory. The storage unit 122 stores information to be used for the operation of the control unit 123 and information obtained by the operation of the control unit 123.

The control unit 123 includes, for example, one or more general-purpose processors such as CPU or a micro processing unit (MPU), or one or more dedicated processors specialized for specific processing. Alternatively, the control unit 123 may have one or more dedicated circuits such as FPGA or ASIC. The control unit 123 comprehensively controls the operation of the terminal device 12 by operating according to a control/processing program or operating according to an operating procedure implemented as a circuit. The control unit 123 transmits and receives various information to and from the server device 10, etc. via the communication unit 121, and executes the operation related to the embodiment.

The positioning unit 124 includes one or more global navigation satellite system (GNSS) receivers. The GNSS includes at least one of a global positioning system (GPS), a quasi-zenith satellite system (QZSS), BeiDou, a global navigation satellite system (GLONASS), and Galileo. The positioning unit 124 acquires position information of the terminal device 12, and sends the position information to the control unit 123.

The input unit 125 includes one or more input interfaces. The input interface is, for example, a physical key, a capacitive key, a pointing device, a touch screen provided integrally with a display, or a microphone that accepts voice input. The input interface may further include a camera that takes in a captured image or an image code, or an IC card reader. The input unit 125 accepts an operation of inputting information to be used for the operation of the control unit 123, and sends the input information to the control unit 123.

The output unit 126 includes one or more output interfaces. The output interface is, for example, a display or a speaker. The display is, for example, a liquid crystal display (LCD) or an electro-luminescence (EL) display. The output unit 126 outputs information obtained by the operation of the control unit 123.

A processor included in the control unit 123 executes a control program to implement the functions of the control unit 123. The control program is a program for causing the processor to function as the control unit 123. Furthermore, some or all of the functions of the control unit 123 may be implemented by a dedicated circuit included in the control unit 123.

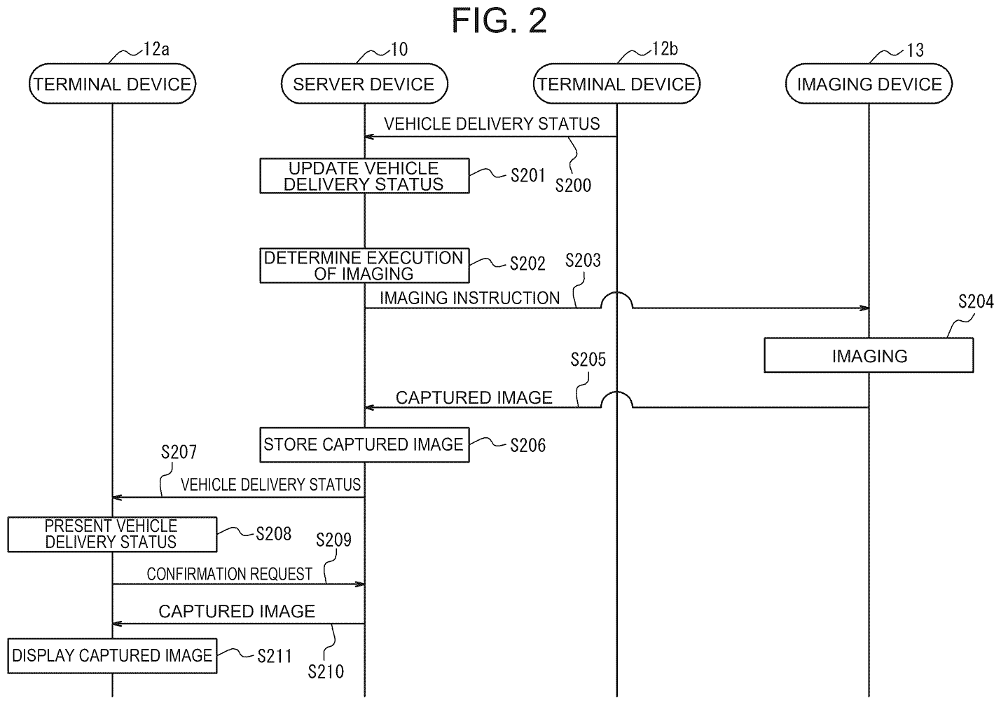

FIG. 2 is a sequence diagram showing the operation procedure of the information providing system 1 in the present embodiment. FIG. 2 shows the procedure for the cooperative operation of the server device 10, the terminal device 12 (hereinafter, the terminal devices 12 to be used by a user and a transporter are referred to as terminal devices 12a and 12b, respectively) and the imaging device 13 when the user checks the current state of the purchased vehicle 15 while waiting for delivery. Steps related to various information processing of the server device 10 and the terminal devices 12a and 12b are executed by the respective control units 103 and 123. Furthermore, steps related to the transmission and reception of various information between the server device 10 and the terminal devices 12a, 12b are executed by the respective control units 103 and 123 transmitting and receiving information via the communication units 101 and 121, respectively. In the server device 10 and the terminal devices 12a, 12b, the respective control units 103 and 123 appropriately store the information to be transmitted and received or processed into the storage units 102 and 122, respectively. Furthermore, in the terminal devices 12a, 12b, a control unit 123 accepts input of various information through input unit 125 and outputs various information through output unit 126.

In step S200, the server device 10 receives information on a vehicle delivery status from the terminal device 12b. The vehicle delivery status is information on the vehicle delivery status of the purchased vehicle 15. The vehicle delivery status is, for example, information indicating at which stage the purchased vehicle 15 is located in the process of vehicle delivery from a factory to a car dealer's store, and includes identification information of the purchased vehicle 15 and identification information of a transport base where the purchased vehicle 15 is located. The information on the vehicle delivery status may include information on a packaging style of the purchased vehicle 15. The packaging style indicates, for example, a kind of packaging in which the purchased vehicle 15 is packaged. The terminal device 12b transmits information on the vehicle delivery status input by the operation of a transporter of the purchased vehicle 15 via the network 11 to the server device 10, and the server device 10 receives the information transmitted from the terminal device 12b.

In step S201, the server device 10 updates the vehicle delivery status. When the server device 10 acquires information on a new vehicle delivery status, the server device 10 updates existing vehicle delivery information with the newly acquired information.

In step S202, the server device 10 determines whether imaging is performed. The server device 10 determines whether the vehicle delivery status is in a situation where imaging should be performed. The situation where imaging should be performed is a situation where the purchased vehicle 15 is located at a transport base where the imaging device 13 is installed on the transport route of the purchased vehicle 15. The server device 10 pre-stores information indicating the presence or absence of the imaging device 13 at each transport base, and determines based on this information whether imaging should be performed. When the server device 10 determines that the vehicle delivery status is in a situation where imaging should be performed, the server device 10 executes step S202 and subsequent steps there onwards. When the server device 10 does not determine that the vehicle delivery status is in a situation where imaging should be performed, steps from step S202 onwards are omitted.

In step S203, the server device 10 sends an imaging instruction to the imaging device 13. The imaging device 13 to which the imaging instruction is sent is an imaging device 13 installed at a transport base where the purchased vehicle 15 is located. The server device 10 associates the identification information of imaging devices 13 installed at respective transport bases and the identification information of the respective transport bases with each other in advance and stores them, and based on the information on a vehicle delivery status, the server device 10 identifies an imaging device 13 at a transport base where the purchased vehicle 15 is located, and sends the imaging instruction to the imaging device 13.

In step S204, the imaging device 13 that has received the imaging instruction performs imaging. The imaging device 13 is installed at a position where it can image the purchased vehicle 15 transported at each transport base. Alternatively, the imaging device 13 may be movable and operated by an operator. The imaging device 13 may perform imaging in response to the imaging instruction under the control of the control device, or may output a notification according to the imaging instruction and perform imaging by an operation of an operator who responds to the notification. The imaging device 13 performs imaging at an arbitrary frame rate to generate a captured image. A moving image may be generated from a plurality of sequential captured images. In the following, when a captured image is mentioned, it also includes a moving image.

In step S205, the server device 10 receives a captured image sent by the imaging device 13. The captured image is time-stamped, for example.

In step S206, the server device 10 stores the captured image.

In step S207, the server device 10 sends information indicating the vehicle delivery status to the terminal device 12a. The server device 10 identifies the terminal device 12 associated with the purchased vehicle 15 based on the vehicle purchase information 107, and sends the information indicating the vehicle delivery status to the terminal device 12. The terminal device 12a receives the information sent from the server device 10.

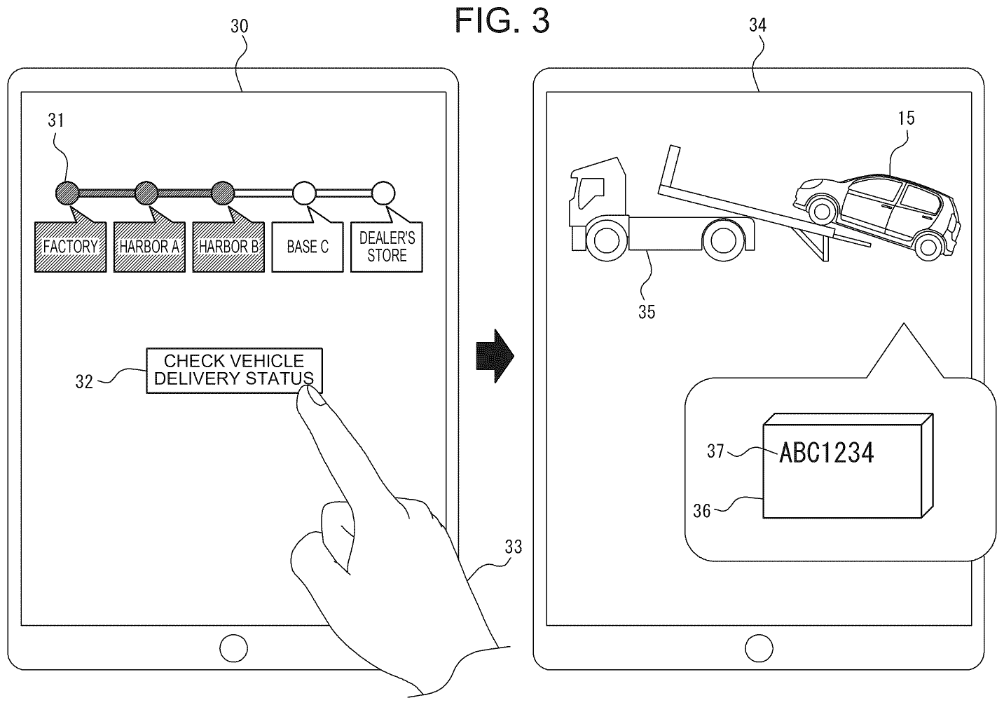

In step S208, the terminal device 12a presents the vehicle delivery status. The terminal device 12a displays, for example, text information, diagrams, and the like indicating the vehicle delivery status to the user. For example, a screen 30 as shown in FIG. 3 is displayed. The screen 30 includes, for example, a diagram 31 indicating the vehicle delivery status. The diagram 31 indicates the transport base to which the purchased vehicle 15 has been transported among transport bases such as “factory,” “port A,” “port B,” “base C,” and “dealer's store,” by changing a display style such as color. Here, the diagram 31 indicates that the purchased vehicle 15 is located at “port B.”

In step S209 of FIG. 2, the terminal device 12a sends a confirmation request to the server device 10. The confirmation request is information for requesting a captured image of the purchased vehicle 15, and it is generated by the terminal device 12a according to a user's operation, for example. For example, on the screen 30 of FIG. 3, the user 33 taps a “check vehicle delivery status” button icon 32 to perform a confirmation request operation. In this case, the confirmation request is information for requesting a captured image of the purchased vehicle 15 located at “Port B”.

In step S210, the server device 10 sends the captured image to the terminal device 12a in response to the confirmation request. The terminal device 12a receives the information sent from the server device 10.

In step S211, the terminal device 12a displays the captured image. For example, as shown in FIG. 3, a screen 34 transitioned from the screen 30 is displayed. The screen 34 includes the captured image of the purchased vehicle 15. In this case, an example of a captured image showing that the purchased vehicle 15 is being loaded/unloaded onto/from a car carrier 35 is shown. The captured image may be a moving image. Furthermore, the captured image may be, for example, a captured image showing that the purchased vehicle 15 is being loaded/unloaded onto/from a ship. Furthermore, the captured image may also be a captured image showing that the purchased vehicle 15 is subjected to a work such as a maintenance work or the like in a factory. Furthermore, the captured image may be a captured image of a cargo 36 such as a container in which the purchased vehicle 15 is packaged. In this case, identification information 37 of the purchased vehicle 15 is attached to the outer surface of the cargo 36, so that the user can recognize it as an image of the purchased vehicle 15 being transported. Such identification information and information on the packaging style are extracted from the information on the vehicle delivery status stored in the server device 10 and sent to the terminal device 12a. The user operates the terminal device 12a and recognizes the identification information of the purchased vehicle 15 and the like by displaying them or the like, and collates the identification information with the identification information 37 attached to the cargo 36 such as the container in the captured image, thereby recognizing that the captured image is the captured image of the purchased vehicle 15.

In this way, the user can check the current state in the transportation process of the purchased vehicle 15 as a specific article that the user has purchased while waiting for the vehicle delivery of the purchased vehicle 15. Therefore, the user's feeling of expectation is inspired while waiting for the vehicle delivery, thereby enhancing the user's interest. A information providing system which allows tracking of the particular vehicle purchased by the user as a specific article and provides images of the particular vehicle showing the current status is thus provided.

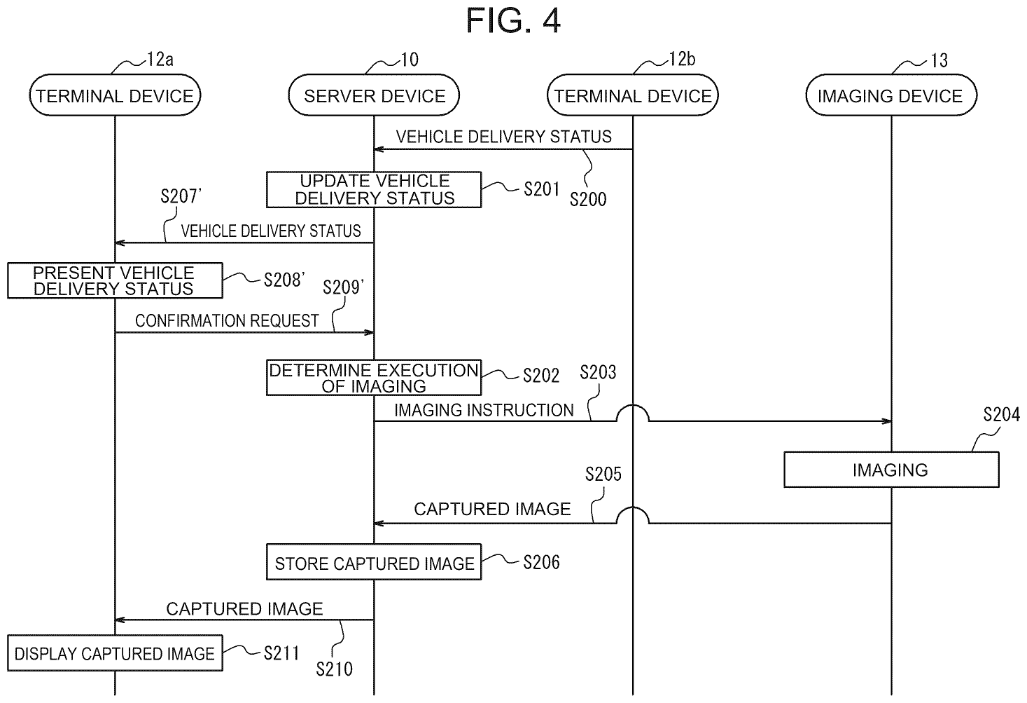

FIG. 4 shows an example of the operation procedure of the information providing system 1 in a modification. The procedure in FIG. 4 is different from that in FIG. 2 in that steps S207, S208, and S209 in FIG. 2 are shifted as steps S207′, S208′, and S209′ between steps S201 and S202, and is otherwise the same as that in FIG. 2.

In this modification, when the server device 10 updates the vehicle delivery status in step S201, the server device 10 sends the information on the vehicle delivery status to the terminal device 12a in step S207′. The terminal device 12a presents the vehicle delivery status to the user in step S208′, and sends a confirmation request to the server device 10 in step S209′. On condition that the server device 10 receives the confirmation request, the server device 10 determines that imaging should be performed in step S202 and sends an imaging instruction to the imaging device 13 in step S203.

According to this modification, imaging is started in response to a request from the terminal device 12a, so that it is possible to provide the user with a captured image with a higher degree of immediacy, thereby making it possible to enhancing the user's interest.

In the above-described embodiment, the processing/control programs that regulate the operation of the terminal device 12 are stored in the storage unit 102 of the server device 10 or in a storage unit of another server device, and may be downloaded to each device via the network 11, or may be stored in a non-transitory recording/storage medium that is readable by each device and read out from the medium by each device.

In the above description, the embodiment has been described based on the drawings and examples, but it should be noted that a person skilled in the art would easily be able to make various modifications and corrections based on the present disclosure. Therefore, it should be noted that these modifications and corrections are included in the scope of the present disclosure. For example, the functions, etc. included in the respective means, steps, etc. can be rearranged so as not to cause logical inconsistencies, and a plurality of means, steps, etc. can be combined into one or divided.

What is claimed is:

1. An information processing device comprising:
a communication device;
a memory configured to store identification information of a specified vehicle and identification information of a terminal device of an owner of the specified vehicle, the identification information of the specified vehicle and the identification information of the terminal device being associated with each other; and
a controller configured to obtain an image captured during transportation of the specified vehicle from an imaging device via the communication device, and send the captured image to the terminal device.

2. The information processing device according to claim 1, wherein the owner of the specified vehicle is a purchaser of the specified vehicle.

3. The information processing device according to claim 2, wherein the controller causes the imaging device to capture an image of the specified vehicle on condition that the specified vehicle is located at a predetermined transport base.

4. The information processing device according to claim 2, wherein the controller causes the imaging device to capture an image of the specified vehicle on condition that a request from the terminal device is received.

5. The information processing device according to claim 4, wherein the controller sends, to the terminal device, information indicating a process in which the specified vehicle is transported.

6. The information processing device according to claim 2, wherein the captured image includes an external appearance of the specified vehicle captured at a transport base of the specified vehicle.

7. The information processing device according to claim 2, wherein the captured image includes an external appearance of a packaging style of the specified vehicle captured at a transport base of the specified vehicle.

8. The information processing device according to claim 7, wherein the external appearance of the packaging style includes the identification information of the specified vehicle.

9. A system comprising an information processing device and a terminal device, the information processing device storing identification information of a specified vehicle and identification information of the terminal device of a purchaser of the specified vehicle, the identification information of the specified vehicle and the identification information of the terminal device being associated with each other, wherein
the information processing device obtains an image captured during transportation of the specified vehicle from an imaging device, and sends the captured image to the terminal device, and
the terminal device outputs the captured image.

10. The system according to claim 9, wherein the information processing device causes the imaging device to capture an image of the specified vehicle on condition that the specified vehicle is located at a predetermined transport base.

11. The system according to claim 9, wherein the information processing device causes the imaging device to capture an image of the specified vehicle on condition that a request from the terminal device is received.

12. The system according to claim 11, wherein
the information processing device sends, to the terminal device, information indicating a process in which the specified vehicle is transported, and
the terminal device outputs the information indicating the process.

13. The system according to claim 9, wherein the captured image includes an external appearance of the specified vehicle captured at a transport base of the specified vehicle.

14. The system according to claim 9, wherein the captured image includes an external appearance of a packaging style of the specified vehicle captured at a transport base of the specified vehicle.

15. A method for operating a system including an information processing device and a terminal device, the information processing device storing identification information of a specified vehicle and identification information of the terminal device of a purchaser of the specified vehicle, the identification information of the specified vehicle and the identification information of the terminal device being associated with each other, the method comprising:
obtaining an image captured during transportation of the specified vehicle from an imaging device and sending the captured image to the terminal device by the information processing device; and
outputting the captured image by the terminal device.

16. The method according to claim 15, wherein the information processing device causes the imaging device to capture an image of the specified vehicle on condition that the specified vehicle is located at a predetermined transport base.

17. The method according to claim 15, wherein the information processing device causes the imaging device to capture an image of the specified vehicle on condition that a request from the terminal device is received.

18. The method according to claim 17, further comprising:
sending, to the terminal device, information indicating a process by the information processing device, the specified vehicle being transported in the process; and
outputting information indicating the process by the terminal device.

19. The method according to claim 15, wherein the captured image includes an external appearance of the specified vehicle captured at a transport base of the specified vehicle.

20. The method according to claim 15, wherein the captured image includes an external appearance of a packaging style of the specified vehicle captured at a transport base of the specified vehicle.
